(19) United States
(12) Patent Application Publication
(10) Pub. No.: US 2014/0237508 A1
(43) Pub. Date: Aug. 21, 2014

(54) Method, Navigation and Display System for Widget Notifications on Internet-Enabled Devices

(71) Applicant: Harald Amundsen, Vikhammer (NO)

(72) Inventor: Harald Amundsen, Vikhammer (NO)

(21) Appl. No.: 14/117,438

(22) PCT Filed: Mar. 28, 2012
(86) PCT No.: PCT/NO12/50053

§ 371 Date: Nov. 13, 2013

(30) Foreign Application Priority Data
May 25, 2011 (NO) 20110767

(51) Int. Cl. H04N 21/482; H04N 21/488; H04N 21/81

(52) U.S. Cl. CPC H04N 21/482; H04N 21/812; H04N 21/4882
USPC 725/34; 725/60

(57) ABSTRACT

System and method for navigation of widgets notifications (21) on a display (20) of a display unit (11), which display unit (11) is provided with an internal or external Internet-enabled device (12) which provides Internet to the display unit (11), and the system includes an internal or external control device (13) for controlling the display unit (11). The Internet-enabled device (12) is arranged for providing widgets and widget notifications (21) on the display (20) of the display unit (11) together with a normal TV-sending or other programs, videos or similar a user (14) desires to watch or use.

### BACKGROUND

The invention relates to a navigation and display system and methods that enable users to navigate historical widgets notifications displayed on the main-picture of an Internet-enabled device.

The invention also relates to a system and methods that allows users to launch the widget during the widget's notification display time, to extend the widget notification display time, and to display targeted advertisements inside the widget notifications.

From WO2011/059335 it is known a widget notification system it is known a navigation and display system for widgets on Internet-enabled devices, where the notifications are known as “sticky-on-change” widgets.

From the publication Matsubara et al: “Context driven web applications for networked DVT” it is known a system for TV widgets that can be organized into context aware widget “profiles”.

From WO 2009057950 it is known a known a widget system for TV that includes tempo widgets that are temporarily shown for a configurable time when activated by the user.

From WO 2009063441 it is known a system and method for managing widgets.

Publication EP 2069900 describes a system and method for managing and using electronic widgets.

From US 2009100361 it is known a system and method for providing dynamically updating applications in a television display environment.

Publication WO 2008131417 describes mobile widget dashboard.

From CA 2622900 it is known self-contained mini-applications system and method for digital television.

From US 20080120547 it is known an apparatus and method for managing the appearance of a graphical user interface, especially for widgets.

WO 2008047192 describes a system and method to administrate and use electronic widgets. The widget client can receive widget notifications from a widget server. Further, a widget or widget client configured to allow a user to browse information may include a method and system for navigation.

From US 20090033517 it is known systems, methods and data products for Internet protocol (IPTV) media content.

From US 20110020250 describes how an interactive timeline user interface may be used for showing communication data from various sources in time order (corresponding to historical order). To reduce the number of timeline items may be rolled up and viewed separately.

### OBJECT

An object of the disclosed system and method is to allow a user to navigate historical widgets notifications displayed on a main picture.

A further object of the disclosed system and method is to allow users to launch a widget during a widget's notification display time.

A further object of the disclosed system and method is to provide possibilities for extending the widget notification display time.

A further object of the disclosed system and method is to display targeted advertisements inside the widget notifications.

### SUMMARY

Notifications on Smart Phones and tablets are typically known as push-notifications. Push-notification allows an application to notify the user of new messages or events without the need to actually open the application, similar to how a text message make a sound and pop up on the device.

A typical widget notification system is described by WO2011/059335, but could in fact be any widget notification system that displays notifications on a main picture.

According to the disclosure there is provided a widgets notification system that provides the users with possibilities to navigate historical widget notifications, for instance, when the user is not using or looking at the display unit for a period. According to the disclosure the system is also arranged for organizing widget notifications.

In addition to provide widgets notification on a display the system according to the system is arranged such that the user can navigate widgets notifications displayed on a main picture.

A system according to the disclosure includes a display unit, provided with an internal or external Internet-enabled device, which provides internet to the display unit.

Examples of Internet-enabled devices 12 are Blu-Ray players, set-top boxes, smart phones and video game consoles that are able to connect to the Internet.

The Internet-enabled device is further provided with software and/or means for displaying and navigation of the system, and an interface for communicating with the display unit.

The display unit can be controlled by a control device, via which control device a user is able to navigate and interact with the display unit. Examples of control devices are remote controls equipped with key buttons, smart devices equipped with an optional interactive display and motion control units with or without key buttons.

The functionality of the control device is depended on the control device in use, and the buttons on the control device is typically physical key buttons, keyboard buttons, or touch and Multi-Touch activated buttons and interactions.

The use of the different buttons on the control device varies with the mode of the system at that specific time.

The display unit could also include the control device in addition to the Internet-enabled device. Examples of this combination are PDAs, mobile phones, and iPhones.

A user may also navigate and interact with the Internet-enabled devices by using his/her speech and/or body motions as an alternative to using physical remote control devices. Examples of this type of interaction are Siri® (speech recognition by Apple Inc.) and Kinect™ (motion recognition by Microsoft Inc.). The definition of remote control devices in the present invention also includes alternative nonphysical devices such as speech and/or body motions.

The word alert is used instead for notification and the word app is used instead for widget in the parts of the document, as the meanings are the same.

Further advantageous details and preferable features of the invention will appear from the following detailed description and associated drawings.

### BRIEF DESCRIPTION OF THE DRAWINGS

The disclosed system and method will below be described in detail with references to the attached drawings, wherein:

FIG. 1 is a principle drawing of a system,

FIG. 2 is a principle system state diagram,

FIG. 3 shows a regular main picture,

FIG. 4 shows an example of a new app alert displayed on Facebook according to the disclosure,

FIG. 5 shows an example of a new app alert displayed on Twitter according to the disclosure, and

FIG. 6 shows an example of a historical app alert displayed on Twitter according to the disclosure.

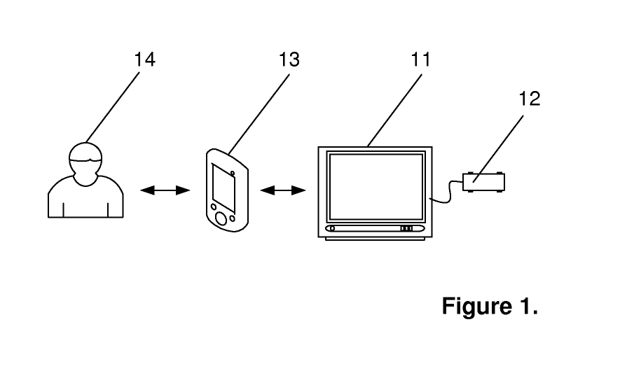

Reference is first made to FIG. 1 which is a principle drawing of a system according to the invention. A system according to the invention includes a display unit 11, provided with an internal or external Internet-enabled device 12, such as Blu-Ray players, set-top boxes, smart phones and video game consoles, which provides internet to the display unit 11.

The Internet-enabled device 12 is further provided with software and/or means for displaying and navigation of the system, and an interface for communicating with the display unit 11.

The display unit 11 can be controlled by a control device 13, such as remote controls equipped with key buttons, smart devices equipped with an optional interactive display and motion control units with or without key buttons, via which control device 13 a user 14 is able to navigate and interact with the display unit 11.

The functionality of the control device 13 is depended on the control device 13 in use, and the buttons on the control device 13 is typically physical key buttons, keyboard buttons, or touch and Multi-Touch activated buttons and interactions.

The use of the different buttons on the control device 13 varies with the mode of the system at that specific time.

The display unit 11 could also include the control device 13 in addition to the Internet-enabled device 12. Examples of this combination are PDAs, mobile phones, and iPhones.

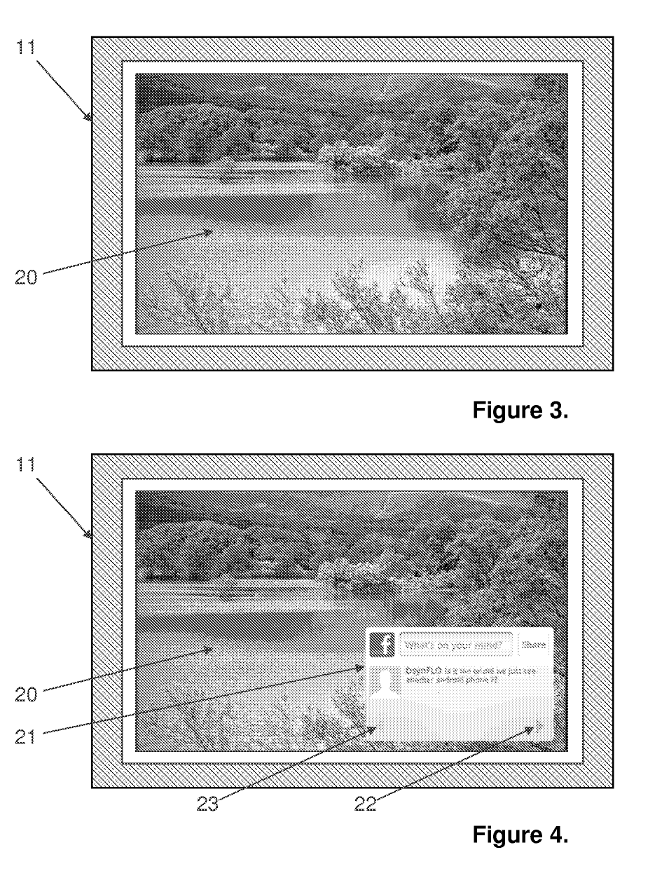

When first turning on the Internet-enabled device 12 it will show its normal content on its display 20 (FIG. 3).

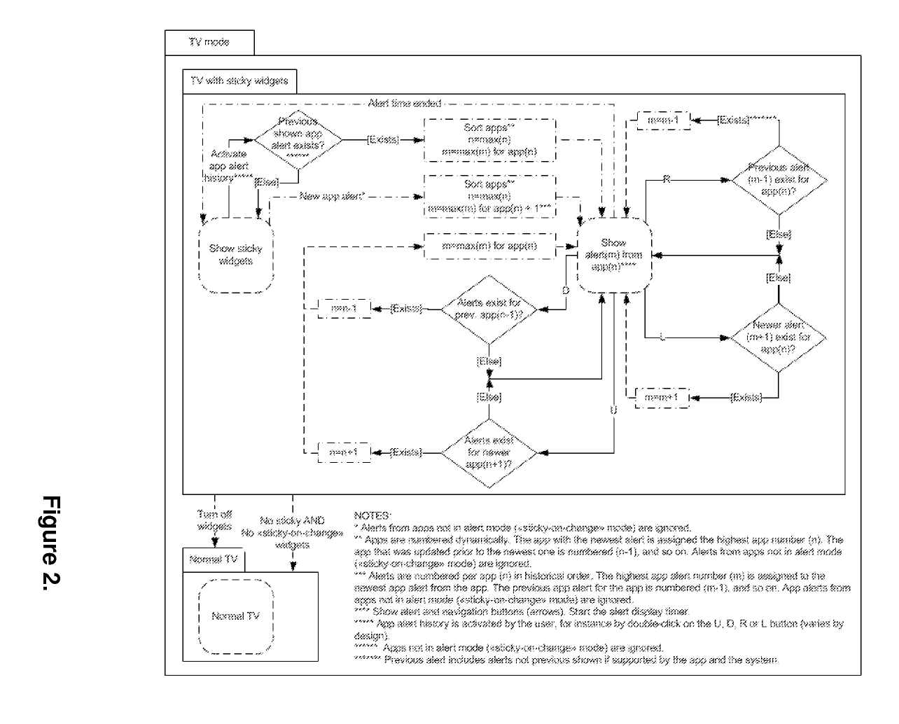

Reference is now made to FIG. 2 which shows a state diagram covering actions from the control device 13 buttons, states and modes. The figure shows that “TV with sticky widgets” is separated into two sub-modes “Show sticky widgets” and “Show alert (m) from app (n)” to add support for navigation and display of historical app alerts in the most user-friendly manner on all kind of Internet-enabled devices 12.

In a system that does not support sticky widgets the mode “TV with sticky widgets” could be renamed to “TV with app alerts”, and “Show sticky widgets” could be renamed to “Ready to display app alerts” as it represents a modus where the system is ready to display new and historical app alerts.

In addition, the word TV in FIG. 2 could be replaced by display unit 11, as the meaning is the same.

In FIG. 2 the states and the change of state due to button pushes are marked with dotted lines. Actions and automatic state changes and others due to these actions, are marked with dotted lines in combination with dots. Branches are marked with solid lines. The buttons used in the state diagram are for illustration purposes.

The arrow buttons ( [symbol] , [symbol] , ▾, ▴) on the control device 13 are labelled L for Left, R for Right, U for Up, and D for Down.

Typically the user 14 will use a system as described by FIG. 2 in WO2011/059335 to select his/her alert mode apps (apps in “sticky-on-change” mode) that provides app alerts on the display 20 of the display unit 11. The system has to support app alerts to function as intended, but it do not need to support sticky widgets.

An app in alert mode that has new or updated data will generate a “New app alert” (notification) as indicated by FIG. 2. Apps not in alert mode will not generate any state changes and will not be numbered by the system.

App alerts from apps in alert mode will be buffered, and stored in the internal memory, to ensure that all app alerts shown on the display 20 of the display unit 11 can be shown by the system again upon need.

Before a state change occurs the alert mode apps will be sorted (numbered) dynamically so its app number represents the historical order in which it was updated. The app with the newest alert will be assigned the highest app number (n). The alert mode app that was updated prior to the newest one will be numbered (n−1), and so on.

The new app alert (m) is also numbered dynamically so the alert number represents the historical order in which it was updated. The new alert will be assigned the highest number, which is the app's previous alert number plus 1.

As indicated by the state “Show alert (m) from app (n)” in FIG. 2 the app alert (m) from app (n) will be shown on the display 20 of the display unit 11 for a predefined number of seconds that varies dependent on the system settings.

Optional historical app alert navigation buttons can be shown together with the app alert if historical alert navigation is possible.

In “Show alert (m) from app (n)” an optional alert sound will only be valid for new app alerts (if turned on), and alert animation will typically only be valid for new app alerts (including buffered app alerts) and when the app number (n) has changed.

If no new state transitions are performed by the system, an automatically state change to “Show sticky widgets” will be performed when the alert display time has ended.

In the following it will be explained how user interactions can result in state changes from the state “Show alert (m) from app (n)”.

If the user 14 activates the previous app alert button, indicated by the letter R in FIG. 2, the system will check if there exist any previous alerts for app (n). If a previous alert exists then a state change to “Show alert (m) from app (n)” will be retriggered and the previous alert (m−1) for app (n) will be shown on the display 20 of the display unit 11 for a predefined number of seconds. No state change will occur if a previous alert do not exist. It will, however, be possible to navigate historical app alerts not previously shown by the system if the system and the app supports it, and if this functionality is turned on (enabled).

If the user 14 activates the next app alert button, indicated by the letter L in FIG. 2, the system will check if there exist any newer alerts for app (n). If a newer alert exists then a state change to “Show alert (m) from app (n)” will be retriggered and the newer alert (m+1) for app (n) will be shown on the display of the display unit 11 for a predefined number of seconds. No state change will occur if a newer alert do not exist.

If the user 14 activates the previous app button, indicated by the letter D in FIG. 2, the system will check if there exist any alerts for app (n−1). If an alert exists then a state change to “Show alert (m) from app (n)” will be retriggered and the newest alert [max(m)] from the previous app will be shown on the display 20 of the display unit 11 for a predefined number of seconds. No state change will occur if an alert for a previous app do not exist.

If the user 14 activates the next app button, indicated by the letter U in FIG. 2, the system will check if there exist any alerts for app (n+1). If an alert exists then a state change to “Show alert (m) from app (n)” will be retriggered and the newest alert (max(m)) from the newer app will be shown on the display 20 of the display unit 11 for a predefined number of seconds. No state change will occur if an alert for a newer app do not exist.

In the following it will be explained how a user 14 can interact with the system to view historical app alerts from apps in alert mode.

If the user 14 activates the historical alerts button in “Show sticky widgets” mode the alert mode apps will be numbered dynamically so that the app number represents the historical order in which it was updated. The app with the newest alert will be assigned the highest app number (n). The alert mode app that was updated prior to the newest one will be numbered (n−1), and so on.

The app's alert numbers will represent the historical order in which it was updated where the newest alert will be assigned the highest number [max(m) for app(n)].

As indicated by the state “Show alert (m) from app (n)” in FIG. 2 the historical alert, if exists, will be shown on the display 20 of the display unit 11 for a predefined number of seconds that varies dependent on the system settings. No state change will occur if no historical app alerts exists.

The alert history is cleared completely when the user 14 brings the system into “Normal” mode.

Reference is now made to FIGS. 3-5 which show an example of an implementation of the system according to the invention where regular TV remote control buttons are used.

The following keys are selected to perform the functions of the system:
arrow buttons ( [symbol] , [symbol] , ▾, ▴), and
W button (a specified “App alert history” button).

When first turning on the internet-enabled device 12, it will show its normal content on the display 20 (FIG. 3).

In this example it is assumed that the system is in “Show sticky widgets” mode with no previous app alerts and no sticky widgets, and that the user 14 has turned on app alerts from Facebook and Twitter.

It is then assumed that the Facebook app has new data (updated or new information) and as a result a new alert 21 is shown on the display 20 of the display unit 11. As FIG. 4 shows there are visual indications showing that previous alerts 22 (enabled right arrow) and no newer alerts 23 (disabled left arrow) exits and are available. Now, the right arrow button [symbol] on the control device 13 will navigate/switch to the previous (historical) Facebook alert during the alert display time (e.g. 5 seconds).

The alert fades away as after e.g. 5 seconds as it is assumed that the user 14 does not operate the control device 13 during the alert display time. Again the Internet-enabled device 12 shows its normal content on its display 20 (FIG. 3).

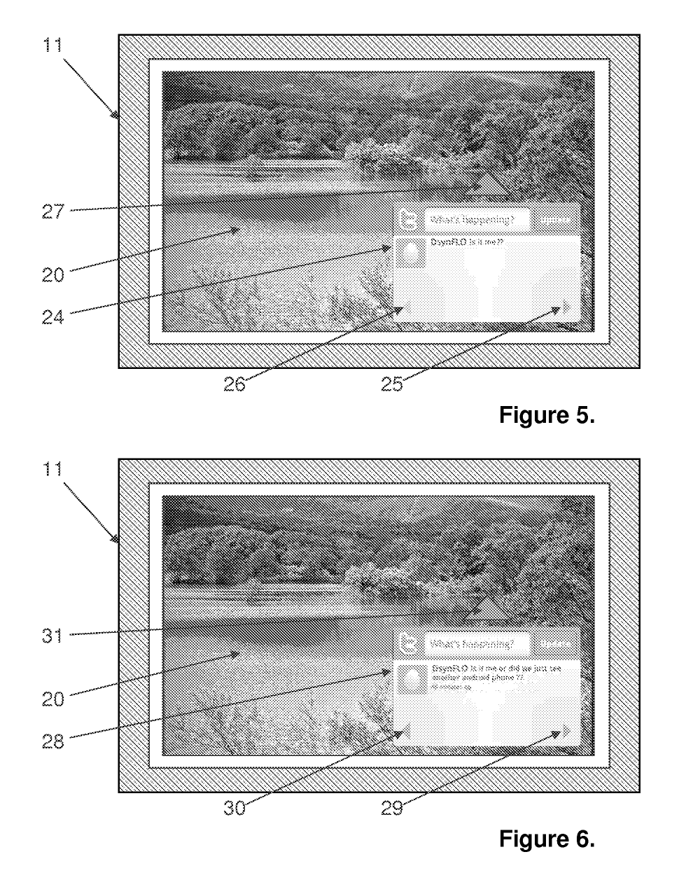

It is then assumed that the Twitter app has new data (is updated) and as a result a new alert 24 is shown on the display 20 of the Internet-enabled device 12. As FIG. 5 shows there are visual indications showing that previous alerts 25 (enabled right arrow) and no newer alerts 26 (disabled left arrow) exits and are available. There is also a visual indication 27 (enabled up-arrow) indicating that alerts from previous app(s) exist.

Now, the right arrow button [symbol] on the control device 13 will navigate/switch to the previous (historical) Twitter alert. The down arrow button ▾, on the control device 13 will navigate/switch to the app that was updated prior to the Twitter app, that is the newest Facebook app alert just shown (FIG. 4). It is only possible to navigate between alerts during the alert display time.

It is then assumed that the user 14 operates the right arrow button [symbol] on the control device 13 during the Twitter alert display time to navigate to a previous (historical) Twitter app alert. Now the previous alert 28 from the Twitter app is shown on the display 20 of the display unit 11 as shown in FIG. 6 and a display alert timer is restarted. As FIG. 6 shows there are visual indications showing that previous alerts 29 (enabled right arrow) and newer alerts 30 (enabled left arrow) exits and are available. There is also a visual indication 31 (enabled up button) indicating that alerts from previous app(s) exists.

The historical alert fades away as after e.g. 5 seconds as it is assumed that the user 14 does not operate the control device 13 during the alert display time. Again the Internet-enabled device 12 shows its normal content on its display 20 (FIG. 3).

It is then assumed that the user 14 operates the “App alert history” button W on the control device 13 to view historical app alerts. Now the newest Twitter alert is shown on the display 20 of the display unit 11 and the user 14 can now navigate historical Facebook and Twitter alerts by operating the arrow buttons on the control device 13.

It is then assumed that the user 14 turns off alerts to bring the system into “Normal” mode and to clear the alert history completely.

The methods and system may be provided with the possibility to launch the widget by operating a “Launch widget” button on the control device 13 during the widget's notification display time.

The methods and system may be provided with the possibility to extend the widget's notification display duration by pressing down a “Hold notification” button on the control device 13 during the widget's notification display time. The widget notification will disappear when the “Hold notification” button is released, but not normally before the notification timer has ended (minimum display time).

The system may be provided with the possibility to display targeted advertisements inside the widget notifications.

The methods and system may be changed so that the notification last displayed by the widget is shown again when the user navigates back-and-forth between the widgets in notification mode, i.e. the widgets notification index is not changed when navigating to a notification from another widget.

The dynamic numbering of the apps and alerts could be different than what is described, by using reverse sorting/order.

The use of navigation arrows could be different, for instance could the right and left arrow be used for opposite purposes.

Visual indications could be different that shown in the figures (illustrative).

1-10. (canceled)

11. A system for providing and navigating widget notifications (21) on a display (20) of a display unit (11), which display unit (11) is provided with an internal or external Internet-enabled device (12) which provides Internet to the display unit (11), which system includes an internal or external control device (13) for controlling the display unit (11), which Internet-enabled device (12) is arranged for providing navigation and presentation of historical widget notifications (21), such as previous notifications from widgets in notification mode, on the display (20) of the display unit (11) together with a normal TV-sending or other programs, videos or similar a user (14) desires to watch, wherein the Internet-enabled device (12) is configured for presentation of the notifications (21) on the display (20) of the display unit (11).

12. The system according to claim 11, wherein the Internet-enabled device (12) is configured to launch the widget during the widget's notification (21) display time.

13. The system according to claim 11, wherein the Internet-enabled device (12) is configured for extending display time of the notification (21) by pressing down a button on the control device (13).

14. The system according to claim 11, wherein the Internet-enabled device (12) is configured to display targeted advertisements inside the widget notifications (21).

15. The system according to claim 11, wherein the Internet-enabled device (12) is provided with:
an Interface for communicating with the display unit (11), and
software or means for controlling, displaying, using and navigating widget notifications (21) on the display (20) of the display unit (11).

16. The system according to claim 11, wherein the Internet-enabled device (12) is arranged for communicating with the control device (13) via the display unit (11).

17. The system according to claim 12, wherein the Internet-enabled device (12) is arranged for communicating with the control device (13) via the display unit (11).

18. The system according to claim 13, wherein the Internet-enabled device (12) is arranged for communicating with the control device (13) via the display unit (11).

19. The system according to claim 14, wherein the Internet-enabled device (12) is arranged for communicating with the control device (13) via the display unit (11).

20. The system according to claim 15, wherein the Internet-enabled device (12) is arranged for communicating with the control device (13) via the display unit (11).

21. The system according to claim 11, wherein the Internet-enabled device (12) is configured for grouping notifications (21) into widgets groups according to the widget they belong to.

22. The system according to claim 11, wherein the Internet-enabled device (12) is configured for dynamically sorting the notifications (21) within the widget groups in time for arranging the notifications (21) within each group in historical order.

23. The system according to claim 11, wherein the Internet-enabled device (12) is configured for on demand one-by-one navigation of the grouped and sorted notifications (21).

24. A method for providing widgets notifications (21) on a display (20) of a display unit (11) together with normal TV-sending or other programs, videos or similar a user (14) desires to watch, comprising the steps of:
navigating historical widget notifications (21) on the display (20) of the display unit (11),
displaying historical widget notifications (21) for a display time on the display (20) of the display unit (11),
launching the widget during the widget's notification (21) display time,
extending the widget notification (21) display time by pressing down a button on the control device (13) during the widget notification (21) display time.

25. The method according to claim 24, comprising the step of grouping and sorting notifications (21) in time according to the widget to which the respective notifications (21) belong to.

26. The method according to claim 25, comprising the step of sorting the widget notification groups in time for later on-demand presentation on the display (20) of the display unit (21).

27. The method according to claim 26, comprising the step of navigating the grouped and sorted notifications on the display (20) of the display unit (11) one-by-on on demand.

28. The method according to claim 25, comprising the step of dynamically sorting the notifications (21) within the widget groups in time for arranging the notifications in each respective widget group in historical order.

29. The method according to claim 24, including the step of activating normal TV or TV with historical widget notifications (21) or sticky widgets or both.
